(19) United States
(12) Patent Application Publication
(10) Pub. No.: US 2020/0234312 A1
(43) Pub. Date: Jul. 23, 2020

(54) POST-PURCHASE PRODUCT INTERACTION

(71) Applicant: ADOBE INC., San Jose, CA (US)

(72) Inventors: William Brandon George, Pleasant Grove, UT (US); Kevin Gary Smith, Lehi, UT (US)

(21) Appl. No.: 16/250,660

(22) Filed: Jan. 17, 2019

(51) Int. Cl. G06Q 30/02; G06Q 30/06

(52) U.S. Cl. CPC G06Q 30/0201; G06Q 30/0282; G06Q 30/0631; G06Q 30/0255; G06Q 30/0204

(57) ABSTRACT

An improved analytics system generates product interest profiles for customers that are related to post-purchase interactions with a product by a customer. The analytics system receives product metadata from a catalog that is related to the product purchased by the customer. The analytics system can further receive social content of the customer from a social channel. The social content is analyzed for post-purchase interactions with the product purchased by the customer. A product interest profile is generated for the customer related to the product based at least in part on the post-purchase interaction.

### BACKGROUND

Business intelligence or analytics systems are computer-based systems that collect and analyze data related to customers. Such analytics systems can provide insight about customers, products, and/or business trends based on analyzed data. Analytics systems often attempt to provide insight into a customer's purchase journey and life cycle of purchasing products. In other words, analytics systems often attempt to answer questions like why a customer decided to purchase a product and/or what is likely to make the customer purchase a product in the future. However, in most cases, analytics systems fail to understand post-purchase product usage and satisfaction resulting in significant gaps in insight into a purchase journey as a whole. Understanding portions of a customer's overall purchase journey like product usage and product sentiment can greatly affect marketing campaign evaluations with regard to targeting a particular customer as well as influence how to retarget to a specific customer. Additionally, understanding product usage and/or product sentiment can greatly affect the process used to identify groups of customers with similar characteristics when performing customer segmentation. Conventional methods used by existing analytics systems have tried several approaches to understand this portion of a customer purchase journey. However, the conventional methods used by existing analytics systems have had limited success in successfully understanding post-purchase interactions a customer has with a purchased product.

### SUMMARY

Embodiments of the present disclosure are directed towards an improved analytics system that generates product interest profiles based on post-purchase interactions with a product by a customer. In accordance with embodiments of the present disclosure, the analytics system combines back-end catalog metadata with social content indicative of post-purchase interactions with a purchased product. By analyzing the post-purchase interactions, the analytics system can determine customer motivation in purchasing the product, usage of the product, and/or sentiment towards the product. Each of these provide insight into customer behavior. Combining back-end catalog metadata with post-purchase social content enables the analytics system to identify and understand a portion of the customer purchase journey previously unavailable.

### BRIEF DESCRIPTION OF THE DRAWINGS

FIG. 1A depicts an example configuration of an operating environment in which some implementations of the present disclosure can be employed, in accordance with various embodiments.

FIG. 1B depicts an example configuration of another operating environment in which some implementations of the present disclosure can be employed, in accordance with various embodiments.

FIG. 2 depicts an example configuration of an operating environment in which some implementations of the present disclosure can be employed, in accordance with various embodiments.

FIG. 3 provides a process flow showing an embodiment of method 300 for generating product interest profiles, in accordance with embodiments of the present disclosure.

FIG. 4 provides a process flow showing an embodiment for generating product interest profiles, in accordance with embodiments of the present disclosure.

FIG. 5 provides a process flow showing an embodiment for generating a product interest profile for a customer using objects extracted from social channel content, in accordance with embodiments of the present disclosure.

FIG. 6 provides a process flow showing an embodiment for generating a product interest profile for a potential customer using objects extracted from social channel content, in accordance with embodiments of the present disclosure.

FIG. 7 depicts an illustrative piece of analyzed social content, in accordance with various embodiments of the present disclosure.

FIG. 8 depicts an illustrative process of implementing a purchase analysis system, in accordance with various embodiments

FIG. 9 is a block diagram of an example computing device in which embodiments of the present disclosure may be employed.

### DETAILED DESCRIPTION

Various terms and phrases are used herein to describe embodiments of the present invention. Some of the terms and phrases used herein are described here, but more details are included throughout the description.

As used herein, the term “social content” refers to both published social content and any associated engagement objects. For instance, social content can include media objects (e.g., images, videos, audio, any other electronic media that can be publicly shared by an entity on a network, such as the Internet, or any combination thereof) and/or a text objects (e.g., URLs, captions, quotes, passages, journal entries, etc.). The social content can also include engagement objects. Engagement objects associated with social content can include one or more interactions that corresponds to each piece of social content. Such interactions can include comments, opinions, “likes”, “dislikes”, “tweets”, “retweets”, hashtags, usernames, user references, emoticons, ASCII art, images, animations, videos, audio, text, URLs, any other electronic media that can be publicly shared on a network, or any combination thereof, by one or more users. The engagement objects, which can include one or more interactions, can be associated with a piece of social content and/or media objects and/or text objects contained therein.

The term “product interest profile” is used herein to refer to a profile generated and/or augmented from analyzed post-purchase product interactions by a customer. The purchase analytics system can leverage back-end catalog metadata to analyze products identified on a social channel of a customer as purchased by the customer. Upon identifying a purchased product, the product interest profile can be based on actual usage of a product by the customer, customer sentiment about a product, customer motivation in purchasing a product, etc. A product interest profile can be generated and/or augmented for a customer that purchased a product of interest. A product interest profile can also be generated and/or augmented for a potential customer that is related to a customer that purchased a product of interest. Such a product interest profile can be added to an overall customer profile.

The term “customer” is used herein to refer to an individual that purchases one or more products from a company. Generally speaking, a customer can purchase a product via a website of the company or in a brick-and-mortar store. A customer purchase can be stored in a company customer database of purchases. A customer can interact with social channels to generate social content including media objects and/or text objects related to a purchased product.

The term “potential customer” is used herein to refer to an individual that is potentially interested in purchasing one or more products from a company. A potential customer can leave one or more pieces of engagement objects corresponding to social content generated by a customer that relates to a purchased product. Using the one or more pieces of engagement objects corresponding to the social content generated by a customer that relates to a purchased product, a likelihood of interest in the product can be determined for the individual that generated the engagement objects.

The term “user” is used herein to refer to a marketer, publisher, editor, author, or other person who employs the analytics tools described herein to view analyzed social content and generated and/or augmented product interest profiles that are based on purchased products. A user can designate important metrics to use in analyzing the social content.

The term “catalog metadata” or “metadata” is used herein to refer to data related to a catalog belonging to a company. The “catalog” can be a back-end catalog containing metadata related to powering a website of the company. Metadata can include information related to displaying products on a website (e.g., product images, product sizing information, color scheme information, product descriptions, etc.). Such metadata can be related to the information used to build product pages. Such metadata can also be related to additional behind-the-scenes data typically not disclosed to customers (e.g., data related to a company that is used to manage inventory, pricing related information, etc.).

A vast amount of data can be gathered that relates to customers of a business (e.g., individuals that purchase a product). Such data can relate to customer characteristics and behaviors as the customer interacts with one or more products purchased from the business. Analytics systems are typically employed to process the vast amount of data to assist in decision-making (e.g., targeted marketing campaigns). Often, analytic systems attempt to analyze and understand an entire customer purchase journey (e.g., from initial motivation of a customer to purchase a product, to how a customer interacts with a company webpage when purchasing a product, to how a customer uses a product, to satisfaction with a purchased product). Of particular interest in this customer purchase journey is gaining insight into what happens after a customer completes a purchase (e.g., how the customer uses a product, sentiment associated with the product, if the customer even opened the box the product was shipped in, etc.). Existing analytics systems use several approaches in an attempt to more fully understand what happens after a customer completes a purchase, however, each of these approaches have drawbacks.

Some existing analytics systems use keyword searches and counts in an attempt to understand the post-purchase portion of a customer purchase journey. Keyword searches and counts can include attention being given to a particular topic, such as a product or event (e.g., searching all public social channels for social content related to “ADOBE PHOTOSHOP”). However, such keyword searches and counts fail to attach purchases to a particular customer. As such, keyword counts fail to provide any insight into the post-purchase portion of a particular customer's purchase journey for a selected product. Keyword searches and counts tend to indicate global interest in the particular topic. Further, when searching for a generic topic (e.g., shoes), the number of returned results is often too numerous to provide insightful information related to a selected product related to the generic topic. In addition, if a topic is indicated using descriptive terms, a direct search and count of keywords will fail to identify the topic (e.g., “look at my purple kicks” to describe a pair of purple shoes). Finally, keyword search and counts fail to analyze and incorporate content from media (e.g., images) accompanying text.

Other analytics systems have used customer reviews and/or feedback in an attempt to understand the post-purchase portion of a customer purchase journey. However, customer reviews and/or feedback are typically polarized. Such polarized satisfaction/dissatisfaction with a product does not accurately reflect the average customer feeling regarding a product. Further, very few customers actually provide reviews and/or feedback that can be used to understand post-purchase interactions with a purchased product.

As such, existing analytics systems are generally deficient in understanding the post-purchase portion of a customer purchase journey or leveraging this understanding for use in retargeting a particular customer and/or identifying similar customers for targeting. Additionally, existing analytics systems are typically incapable of analyzing post-purchase interactions with a product (e.g., such as actual use of the product by a customer). Further, existing analytic systems often fail to identify a customer's motivation in purchasing a particular product.

Accordingly, embodiments of the present disclosure are directed to an improved analytics system (referred to herein as a purchase analytics system) that addresses the technical deficiencies of existing analytics systems with respect to analyzing and understanding post-purchase customer interactions. In particular, and as described herein, the purchase analytics system generates product interest profiles for customers and/or potential customers related to a purchased product of interest. A generated product interest profile can refer to a newly created product interest profile and/or an augmented (e.g., updated) product interest profile. To generate such a profile, the product analytics system combines back-end catalog metadata with social content indicative of post-purchase usage of a purchased product to identify customer interactions with the product (a portion of a customer purchase journey previously unavailable). Advantageously, such a system can leverage these post-purchase customer interactions to provide insight into customer behavior. This insight can be used in customer segmentation to identify similar customers to target in marketing campaigns. For instance, the product analytics system can accurately identify motivation of a customer in purchasing a product such that similar customers can be better understood and targeted in the future. In this way, the product interest profiles can be combined from multiple customers to provide insight into how customers interest with a particular product (e.g., use at home or work, happy with the product, etc.) The product interest profiles can be used as an additional metric during customer segmentation, for instance, for greater personalization when generating targeted marketing campaigns for related customers. Further, the product interest profile generated by the product analytics system can be added to a customer profile and used, for instance, for greater personalization when generating targeted marketing campaigns for the customer.

As described herein, the purchase analytics system analyzes post-purchase product interactions. At a high-level, to analyze post-purchase product interactions, the purchase analytics system leverages back-end catalog metadata to analyze products identified on a social channel as purchased by a customer. In analyzing the products, customer usage, sentiment, motivation for purchase, related customer interest, etc., can be identified and used to generate a product interest profile. Combining back-end catalog metadata with post-purchase social content can be used to identify and understand a portion of the customer purchase journey previously unavailable. When applied to existing customers, a product interest profile can be indicative of a customer's motivation for purchasing a product, satisfaction with a product, etc. Additionally, a product interest profile can be indicative of interest by a potential customer to a customer's purchased product.

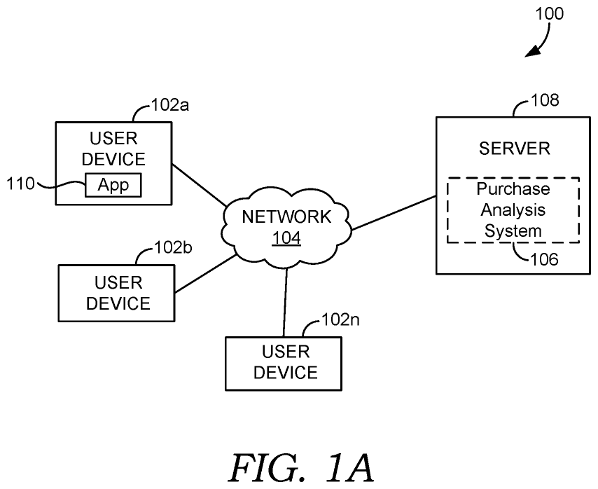

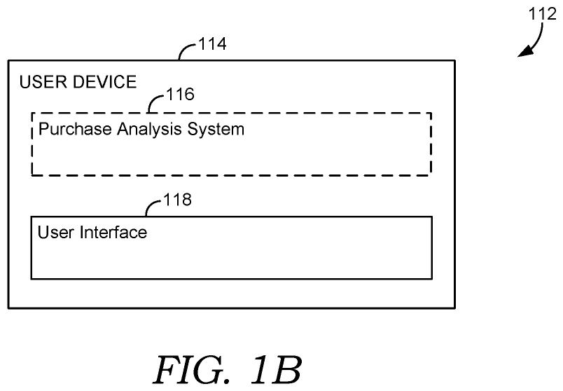

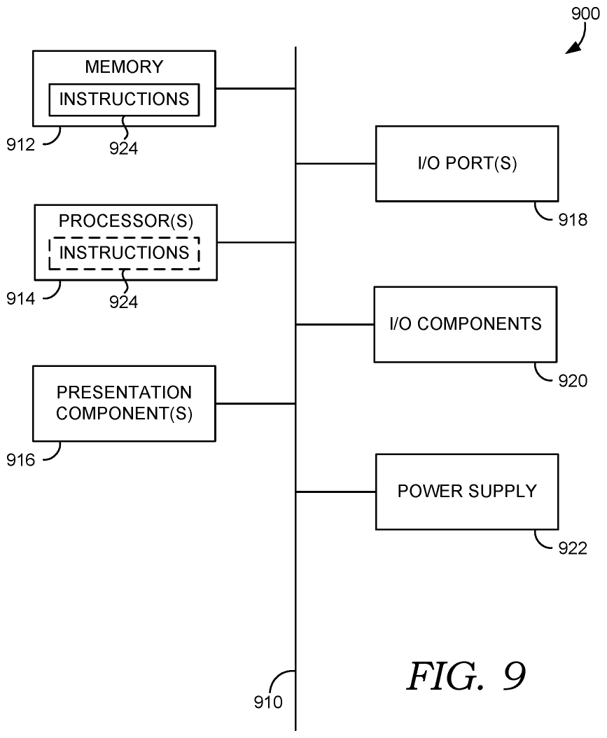

Turning now to FIG. 1A, an example configuration of an operating environment is depicted in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 9.

It should be understood that operating environment 100 shown in FIG. 1A is an example of one suitable operating environment. Among other components not shown, operating environment 100 includes a number of user devices, such as user devices 102a and 102b through 102n, network 104, and server(s) 108. Each of the components shown in FIG. 1A may be implemented via any type of computing device, such as one or more of computing device 900 described in connection to FIG. 9, for example. These components may communicate with each other via network 104, which may be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 104 is not described in significant detail.

It should be understood that any number of user devices, servers, and other components may be employed within operating environment 100 within the scope of the present disclosure. Each may comprise a single device or multiple devices cooperating in a distributed environment.

User devices 102a through 102n can be any type of computing device capable of being operated by a user. For example, in some implementations, user devices 102a through 102n are the type of computing device described in relation to FIG. 9. By way of example and not limitation, a user device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user devices can include one or more processors, and one or more computer-readable media. The computer-readable media may include computer-readable instructions executable by the one or more processors. The instructions may be embodied by one or more applications, such as application 110 shown in FIG. 1A. Application 110 is referred to as a single application for simplicity, but its functionality can be embodied by one or more applications in practice. As indicated above, the other user devices can include one or more applications similar to application 110.

The application(s) may generally be any application capable of facilitating the exchange of information between the user devices and the server(s) 108 for generating and/or updating a product interest profile for a customer. Such a product interest profile can be used in retargeting a customer and/or targeting new customers. In some implementations, the application(s) comprises a web application, which can run in a web browser, and could be hosted at least partially on the server-side of environment 100. In addition, or instead, the application(s) can comprise a dedicated application, such as an application having customer analytics functionality. In some cases, the application is integrated into the operating system (e.g., as a service). It is therefore contemplated herein that “application” be interpreted broadly.

In accordance with embodiments herein, the application 110 facilitates generating/updating a product interest profile for a customer related to a particular purchased product. In embodiments, a product of interest can be selected, for instance, by a user of application 110. A “user” can be a marketer, publisher, editor, author, or other person who employs the product analytics system to analyze social content and view generated product interest profiles based on purchased products. A user can designate important metrics for use in generating a product interest profile directed towards a particular area of interest to better understand customers' interactions with the product of interest (e.g., whether a product is used at home or at work). Based on the selected product of interest and/or any designated metrics, a product interest profile can be generated for one or more customers.

The product interest profile can be based on actual usage of a product by the customer, customer sentiment about a product, customer motivation in purchasing a product, etc. In embodiments, a product interest profile can be generated for a customer that purchased the product of interest. In further embodiments, a product interest profile can also be generated for a potential customer related to a customer that purchased the product of interest. Such a product interest profile can be added to an overall customer profile. Such a product interest profile can provide a connection between available catalog metadata and customer post-purchase behavior (e.g., interactions with a purchased product). In particular, back-end catalog metadata can be leveraged to analyze customer social content depicting post-purchase usage of a purchased product to gain insight into the entirety of a customer purchase journey.

The generated product interest profile can be added to a customer profile. The customer profile can include information about a customer related to online behavior and other interactions with a company (e.g., products purchased, etc.). Results of the product interest profile can be output to a user, for example, via the user device 102a. Such output can be used in performing customer segmentation, retargeting of the customer that purchased the product of interest and/or targeting a customer related to the customer that purchased the product. As an example, application 110 can be an application associated with ADOBE CREATIVE CLOUD.

As described herein, server 108 facilitates the analysis of customer interest of a purchased product via product analytics system 106. Server 108 includes one or more processors, and one or more computer-readable media. The computer-readable media includes computer-readable instructions executable by the one or more processors. The instructions may optionally implement one or more components of product analytics system 106, described in additional detail below.

Product analytics system 106 can generate a product interest profile for a customer. The system can employ metadata from a back-end catalog related to a purchased product. For instance, a website (e.g., NORDSTROM.COM) can have an associated back-end catalog that contains the metadata required to power the website (e.g., images of products, sizing information, color schemes, descriptions of products, etc.). Such metadata can include not just the data built into the customer-side of the website but behind-the-scenes information not typically disclosed to a customer (e.g., actual cost of a product).

For cloud-based implementations, the instructions on server 108 may implement one or more components of product analytics system 106, and application 110 may be utilized by a user to interface with the functionality implemented on server(s) 108. In some cases, application 110 comprises a web browser. In other cases, server 108 may not be required, as further discussed with reference to FIG. 1B. For example, the components of product analytics system 106 may be implemented completely on a user device, such as user device 102a. In this case, product analytics system 106 may be embodied at least partially by the instructions corresponding to application 110.

Referring to FIG. 1B, aspects of an illustrative product analytics system are shown, in accordance with various embodiments of the present disclosure. FIG. 1B depicts a user device 114, in accordance with an example embodiment, configured to allow for product analytics system 116 to generate a product interest profile for a customer based on analyzing social content using metadata related to a purchased product. The user device 114 may be the same or similar to the user device 102a-102n and may be configured to support the product analytics system 116 (as a standalone or networked device). For example, the user device 114 may store and execute software/instructions to facilitate interactions between a user and the product analytics system 116 via the user interface 118 of the user device.

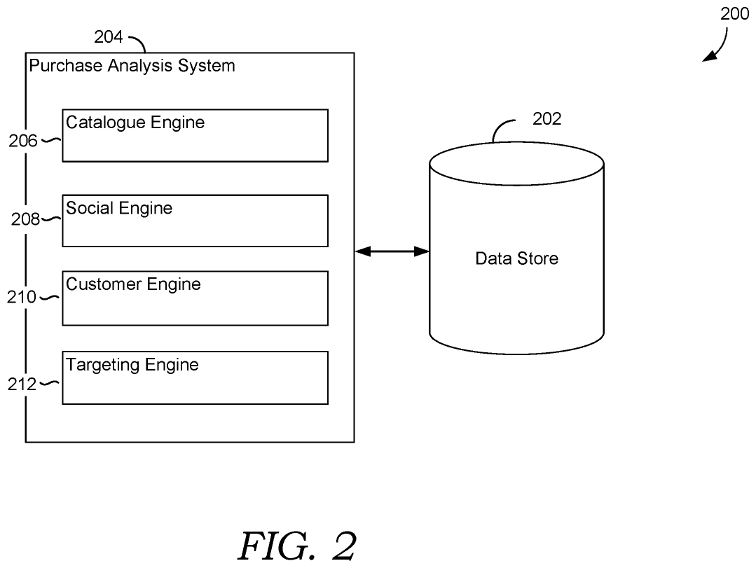

FIG. 2 depicts an example configuration of an operating environment in which some implementations of the present disclosure can be employed, in accordance with various embodiments. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 9. It should be understood that operating environment 200 shown in FIG. 2 is an example of one suitable operating environment. Among other components not shown, operating environment 200 includes a number of user devices, networks, and server(s).

As depicted, product analytics system 204 includes catalog engine 206, social engine 208, customer engine 210, and targeting engine 212. The foregoing engines of product analytics system 204 can be implemented, for example, in operating environment 100 of FIG. 1A and/or operating environment 112 of FIG. 1B. In particular, those engines may be integrated into any suitable combination of user devices 102a and 102b through 102n and server(s) 106 and/or user device 114. While the various engines are depicted as separate engines, it should be appreciated that a single engine can perform the functionality of all engines. Additionally, in implementations, the functionality of the engines can be performed using additional engines and/or components. Further, it should be appreciated that the functionality of the engines can be provided by a system separate from the product analytics system.

As shown, product analytics system 204 operates in conjunction with data store 202. Data store 202 stores computer instructions (e.g., software program instructions, routines, or services), data, and/or models used in embodiments described herein. In some implementations, data store 202 stores information or data received via the various engines and/or components of product analytics system 204 and provide the engines and/or components with access to that information or data, as needed. Although depicted as a single component, data store 202 may be embodied as one or more data stores. Further, the information in data store 202 may be distributed in any suitable manner across one or more data stores for storage (which may be hosted externally).

In embodiments, data stored in data store 202 includes catalog metadata. Catalog metadata generally refers to data related to powering a website. Metadata can include information related to displaying products on a website (e.g., product images, product sizing information, color scheme information, product descriptions, etc.). Such metadata can be related to the information used to build product pages. Such metadata can also be related to additional behind-the-scenes data typically not disclosed to customer (e.g., data related to a company that is used to manage inventory, pricing related information, etc.).

Data store 202 can also store social content. In some instances, social content can include all available social posts and associated engagement objects from one or more social channels for a particular customer that purchased a particular product. For example, the social content can include all social posts and engagement objects on a customer's FACEBOOK page over a given time period related to a particular product. Each piece of social data may correspond to a different social channel at which the piece of social data is available (e.g., FACEBOOK, INSTAGRAM, TWITTER, PINTEREST, etc.).

In particular, the social content can be parsed and stored based on content type (e.g., media objects, text objects, engagement objects). In some configurations, a media object and/or text object of social content can be retrieved using a parser to access a URL associated with the social channel and download raw media files and/or raw text files related to the social content. In some other configurations, media objects and/or text objects of each piece of social content can be retrieved using a web crawler to access the URL associated with each piece of social content and download raw media files and/or raw text files from each URL as necessary. The retrieved raw media objects and/or raw text objects can then be stored data store 202. The data store can include media objects such as images, videos, audio, any other electronic media that can be publicly shared by an entity on a network. The data store can also include text objects such as URLs, captions, quotes, passages, journal entries that are associated with each piece of social content. Such text objects can be associated with a related media object parsed from the same social content (e.g., post). Engagement objects associated with a piece of social content can include a total number of views, unique visitors, likes, dislikes, emoticons (e.g., happy face, sad face), shares, retweets, comments, hashtags, references, URLs, and the like. Such engagement objects can also be associated with a related media object and/or text object parsed from the same social content (e.g., post).

Further data stored in data store 202 can include training data and/or related trained systems. Training data generally refers to data used in machine learning, or portion thereof. It is contemplated that machine learning processes can identify social content related to purchased products. By way of example, the purchased product is a shirt, social content on social channels of a customer that purchased the shirt can be analyzed by machine learning processes to identify whether social content relates to the shirt. Social content identified as related to a purchased shirt can further be analyzed by machine learning processes to determine post-purchase customer interactions with the purchased product. For instance, machine learning processes can be used to evaluate usage of the purchased product, estimate motivation for purchasing the product, determine customer sentiment related to the purchased product, etc. Moreover, text objects and/or engagement objects can be analyzed to provide further insight into post-purchase interactions with the product by the customer (e.g., sentiment regarding the product, motivation to purchase, issues with quality of the product). Additionally, potential customers can be identified based on engagement objects indicating a high likelihood of interest in purchasing the product (e.g., “I love this shirt, where can I buy it!”).

Product analytics system 204 can generate a product interest profile that can be used for better understanding a customer. Such a system can leverage metadata of a catalog to identify and analyze purchased products related to a customer using social content posted to various social channels. Upon identifying purchased products in social content of a customer, a product interest profile can be determined. The product interest profile can provide insight into analyzed customer behavior related to the purchased product. Such customer behavior can include post-purchase interactions with a purchased product. In particular, the product analytics system 204 can access social channels to identify media and/or text objects associated with social content that relates to a particular product.

Catalog engine 206 can obtain metadata related to a product of interest. Metadata can be received from a back-end catalog using a product identifier. In an embodiment, the metadata can be retrieved from data store 202. In other embodiments, the metadata can be retrieved from a server that stores a catalog for a company. Catalog metadata can generally refer to data related to powering a website related to a company (e.g., product images, product sizing information, color scheme information, product descriptions, etc.). For instance, a website (e.g., NIKE.COM) can have an associated back-end catalog that contains the metadata required to power the website (e.g., images of products, sizing information, color schemes, descriptions of products, etc.). Such metadata can include not just the data built into the customer-side of the website but behind-the-scenes information not typically disclosed to a customer (e.g., actual cost of a product). For example, metadata obtained for a pair of NIKE shoes could include image of the shoes (from various angles), colors of the shoes, a description of the shoes, market price for the shoes, at-cost price for the shoes, etc.

Social engine 208 can obtain social content from social channels. Social content can include one or more pieces of social content or social “posts,” each of which can include at least one of a media object, a text object, an engagement object, or any combination thereof. A social channel can include any one of a social media feed, a social media page, a webpage, a landing page, a blog, an electronic form, or any publically-accessible electronic medium that can provide for customer interaction with social content published thereon. By way of example only, the social engine can obtain the social content by retrieving it directly from a social channel, receiving it as one or more data files, receiving it from a database, or receiving it as raw data, among other methods.

In some instances, the social content can include all available social posts and any associated engagement objects from one or more social channels for a customer that purchased a particular product. For example, the social content could include all social posts and engagement objects on a customer's FACEBOOK page over a given period of time. It should be appreciated that all social content on a social channel for a selected period of time can be received and then analyzed to determine the social content that relates to the particular product. Each piece of social content can correspond to a different social channel at which the piece of social content is available (e.g., FACEBOOK, INSTAGRAM, TWITTER, PINTEREST, etc.). In other instances, social content can relate only to the purchased product. For example, the social content could include the social posts and engagement objects on a customer's FACEBOOK page over a given period of time related to a particular product.

In embodiments, upon receiving social content, the social content can be parsed for analysis based on content type (e.g., media object, text object, engagement object). In some configurations, a media object of social content can be retrieved using a parser to access a URL associated with the social channel and download raw media files related to the social content. In some other configurations, media objects of each piece of social content can be retrieved using a web crawler to access the URL associated with each piece of social content and download raw media files from each URL as necessary. The retrieved raw media objects can then be analyzed. In some configurations, a text object of social content can be retrieved using a parser to access a URL associated with the social channel and download raw text files related to the social content. In some other configurations, text objects of each piece of social content can be retrieved using a web crawler to access the URL associated with each piece of social content and download raw text files from each URL as necessary. The retrieved raw text objects can then be analyzed. Engagement objects for each piece of social content can include a total number of views, unique visitors, likes, dislikes, emoticons (e.g., happy face, sad face), shares, retweets, comments, hashtags, references, URLs, and the like. The engagement objects may also include information regarding each view or unique visitor, such as time stamps when accessed, length of time viewed, and visitor characteristics (e.g., demographics such as gender, age, geolocation, etc.). Parsed media objects, text objects, and/or engagement objects can be stored for analysis related to a particular product (e.g., stored in data store 202).

Customer engine 210 can generate product interest profiles for customers. In embodiments, the customer engine 210 can analyze social content utilizing catalog metadata to determine post-purchase behavior related to a purchased product. In particular, the customer engine 210 can obtain metadata from a catalog related to a particular product. The metadata can be used to analyze social content of the customer from a selected time frame. In embodiments, the metadata can be used to identify one or more of a media objects text object, and/or engagement objects that correlate to a particular product. The metadata can include, for example, descriptive information about a product, image(s) of the product from various viewpoints, etc. This metadata can be used to search the social content of a customer known to have purchased a particular product. For instance, a customer's social content can be searched using image recognition (e.g., machine learning processes trained to identify products using descriptive information, images of products from various viewpoints, different colors, etc.) to identify media (e.g., an image) in which a purchased product appears. Examples of social content containing purchased products include: an image can be determined to depict a customer wearing a purchased shirt, a video of can show a customer installing a purchased auto part, a customer can post a picture of herself with her friends at a concert she bought tickets for, a customer can post a picture of himself using a purchased tool, and/or a customer can post an image of a final construction product and mentions a purchased tool in the post (i.e., “Used my brand new router to build this amazing birdhouse.”).

Purchased products can be identified in social content using a confidence score such that social content is identified as containing an object related to a purchased product only when the confidence score is above a predefined threshold level. Such a score can be a cumulative score based on one or more objects related to the purchased product being present within a piece of social content. Additionally, context can be used to increase a confidence score because the system knows that a selected product was purchased by a particular user. For instance, because a purchase analysis system is aware that a customer bought a shirt in the past week, when a piece of social content appears to depict the customer wearing the purchased shirt, the confidence score that the shirt is in the social content is increased.

Upon searching a customer's social content using metadata associated with a purchased product, objects related to the product can be identified (e.g., media objects, text objects, and/or engagement objects). Objects positively identified as being related to a particular product can then be analyzed to determine post-purchase interactions by the customer. Post-purchase interactions can be indicative of motivation for the customer purchasing the product in the first place, customer sentiment associated with the product, how/how often the customer is using the product, etc. In an embodiment, a customer's available social content can be analyzed (e.g., using image recognition) using catalog metadata related to a purchased product to identify purchased products depicted in the social content.

When a piece of social content is determined to contain an object related to the purchased product, such as the purchased product showing up in a post, the social content can be further analyzed. Such analysis can include analyzing the social content objects to determine whether the social content is about the purchased item or whether the purchased product is just visible in the social content (e.g., whether the social content features the purchased product or just happened to contain the purchased product). This analysis can be performed by determining additional contextual information about the social content using the media objects, text objects, and/or engagement objects. For instance, a media object can be analyzed to determine whether the purchase product is featured. As an example, if the purchased product is a shirt, the shirt could be featured in an image when the customer is wearing the shirt and pointing at the shirt. Related text object can also be analyzed to determine whether the purchase product is featured. As an example, if the purchased product is a shirt, the shirt could be featured in an image when the customer is wearing the shirt and the social content is captioned with a text object “Look at my awesome new shirt!” Machine learning can also be applied to determine whether a purchased product is featured in social content. For instance, machine learning can be used to train the customer engine 210 (or a portion of the engine 210) based on social content and objects present in the social content to identify whether an object is featured. As a training dataset, social media influencers' posts and related promoted content could be used to train such an identifier.

Further analysis that can be performed when social content relates to the purchased product can include determining customer sentiment for the purchased product. Customer sentiment can be determined based on media object analysis and/or text objects related to the social content. Image analysis can be performed using a variety of techniques including a sentiment identifier trained using machine learning processes. For instance, if a customer is wearing a newly purchased hat and smiling in a piece of social content, sentiment can be inferred (e.g., that the customer likes the hat). Sentiment about a purchase product can also have a temporal aspect. For example, if a customer bought a dress three years ago and the dress still shows up regularly in social content posted by the customer, sentiment can be inferred (e.g., that the customer really likes the dress). Sentiment can further be inferred based on customer usage metrics, or how often a customer uses a product. A customer usage metric can be an explicit countable metric (e.g., the product showed up in a piece of social content=+1, the product was used=+1, etc.). Sentiment can more directly be determined based on text objects related to the social content. When a text object accompanies a piece of social content, the text object can convey a customer's sentiment (e.g., “BOOOOO, my brand new hat just broke, what a waste of $$$.”).

Further analysis that can be performed when social content relates to the purchased product can include estimating customer motivation for purchasing a product. Motivation for purchasing a product can be determined post-purchase based on how a customer uses the purchased product. As an example, if a customer searches for hiking boots and then buys hiking boots. Post-purchase usage of the hiking boots can be analyzed using social content for the customer. In particular, a customer can use the hiking boots to go hiking in the desert. Motivation can be an advantageous piece of a customer journey when using lookalike modeling to make recommendation to similar customers based on customer segmentation. In the above example, if a second customer is determined to be similar to the customer that searched for hiking boots, the assumption can be made to treat the second customer similar to the initial customer. For instance, if the initial customer purchased crampons along with the hiking boots, crampons can be suggested to the second customer.

Other metrics can be analyzed when social content relates to the purchased product based on interest by a user (e.g., interest of a company selling the purchased product). Such metrics can include where a purchased product is used (e.g., at home or at work), the environment where a purchased product is used, the setting, whether other individuals are involved, whether other individuals in the social content are using the same product. Additional metrics can be explicit countable metrics, customer usage metrics, sentiment analysis, etc.

Engagement objects related to the social content with identified purchased products can also be analyzed. Engagement objects associated with social content can include one or more interactions that corresponds to each piece of social content. Such interactions can include comments, opinions, “likes”, “dislikes”, “tweets”, “retweets”, hashtags, usernames, user references, emoticons, ASCII art, images, animations, videos, audio, text, URLs, any other electronic media that can be publicly shared on a network, or any combination thereof, by one or more users. The engagement objects, which can include one or more interactions, can be associated with a piece of social content and/or media objects and/or text objects contained therein. Analyzing engagement objects provides insight into what other individuals related to the customer think about the purchased product (e.g., a comment on a post: “I love this product, I want one just like it!”). This insight can lead to some of those individuals being identified as potential customers.

The various analysis and results determined by customer engine 210 can be compiled into a product interest profile for a customer. The product interest profile can include data related to customer interactions with a particular product. Such a profile can also include what metadata was used to identify the product in the customer's social content. The product interest profile can be updated over time. In some embodiments, the product interest profile can be updated at predefined time intervals. In other embodiments, the product interest profile can be updated each time a customer buys a product (e.g., the profile can include information related to every product a customer has bought from a particular company). Such a product interest profile can be integrated into a customer profile. A customer profile can include data related to online behavior (e.g., products viewed, pages visited, frequency of visiting, number of visits before making a purchase, acquisition channels to get to website), devices used, purchases made, explicitly observed profile information (e.g., name, social handles for various social channels), inferred profile information (e.g., gender), social perspective (e.g., number of posts, number of followers, who is following), etc.

Targeting engine 212 can leverage information stored in a customer profile, including a product interest profile to target a customer. Targeting can be for a new product that is unrelated to the purchased product or targeting can be retargeting for a product related to the purchased product. The information in the customer profile can be used in customer segmentation to identify similar customers to target in marketing campaigns. For instance, the product analytics system can accurately identify motivation of a customer in purchasing a product such that similar customers can be better understood and targeted in the future. In this way, the product interest profile can be used during customer segmentation, for instance, for greater personalization when generating targeted marketing campaigns for related customers. Further, the product interest profile generated by the product analytics system can be added to a customer profile and used, for instance, for greater personalization when generating targeted marketing campaigns to the customer.

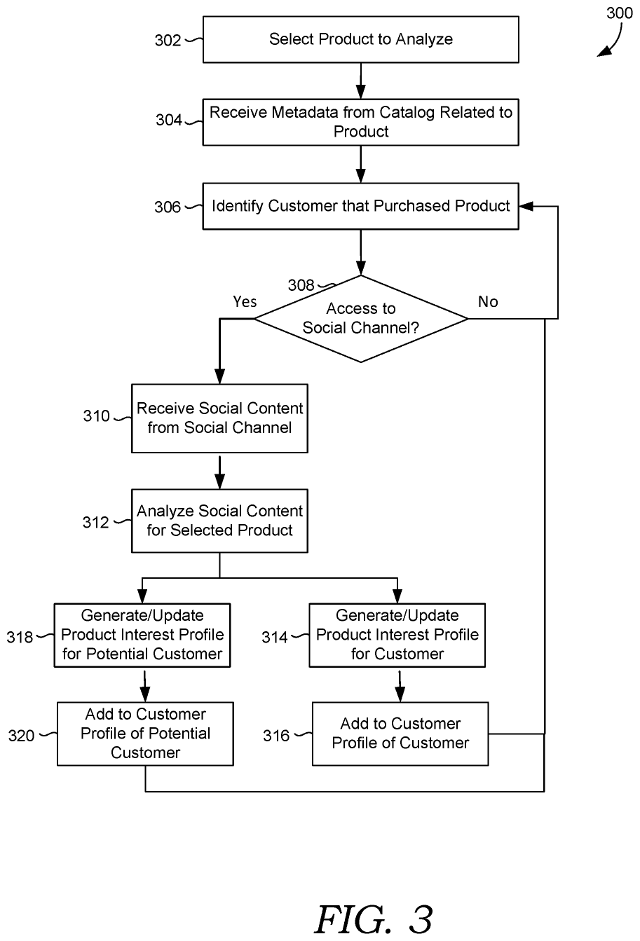

Turning now to FIG. 3, a process flow shows an embodiment of method 300 for generating product interest profiles, in accordance with embodiments of the present disclosure. Method 300 can be performed, for example by product analytics system 204, as illustrated in FIG. 2.

At block 302, a product is selected for analysis. A product of interest can be selected, for instance, by a user. A “user” can be a marketer, publisher, editor, author, or other person who employs the analytics tools described herein to view analyzed social content and generated product interest profiles that are based on purchased products. A product can also be automatically selected based on a predetermined analysis list (e.g., analyzing a particular product sold by a company each week, once a month, etc.).

At block 304, metadata related to the product is received from a catalog. Catalog metadata can generally refer to data related to powering a product webpage of a website. Metadata can include product information related to displaying a webpage of the product of interest (e.g., product images, product sizing information, color scheme information, product descriptions, etc.).

At block 304, one or more customers that purchased the product of interest are identified. Customers can be identified as individuals that have purchased the product within a set time frame (e.g., the past week, month, three months, etc.). In other embodiments, customers can be identified as individuals that have purchased the product without a temporal limit. Customers can be individuals that have made purchases from a company website and/or a brick-and-mortar store. Upon identifying the customers that purchased the product of interest, at block 308, it is determined whether or not the customer has an accessible social channel. An accessible social channel can be a public social channel or a social channel that the customer has granted access to. An accessible social channel can also be social channels for which a purchase analysis system has a stored social handle for the customer. Such a social handle can be linked to a particular customer using a customer profile. If the system does not have access to any social channel for a customer at block 308, the system will identify a different customer that purchased the product at block 306.

If the system has access to one or more social channels for the customer, at block 308, the process continues to block 310 where social content is received from at least one social channel the system is capable of accessing. Social content can include one or more pieces of social content or social “posts,” each of which can include at least one of a media object, a text object, an engagement object, or any combination thereof. A social channel can include any one of a social media feed, a social media page, a webpage, a landing page, a blog, an electronic form, or any publically-accessible electronic medium that can provide for customer interaction with social content published thereon. By way of example only, the social engine can obtain the social content by retrieving it directly from a social channel, receiving it as one or more data files, receiving it from a database, or receiving it as raw data, among other methods.

At block 312, the received social content is analyzed for the selected product. In some embodiments, the social content can be parsed for analysis based on content type (e.g., media objects, text objects, engagement objects). Social content for a customer is analyzed using metadata associated with the selected product to identify related objects (e.g., media objects, text objects, and/or engagement objects). Social content with objects positively identified as related to a particular product can then be analyzed to determine post-purchase interactions by the customer. Post-purchase interactions can be indicative of motivation for the customer for having purchased the product in the first place, customer satisfaction with the product, how/how often the customer is using the product, etc. In an embodiment, a customer's available social content can be analyzed (e.g., using image recognition), based on catalog metadata related to a purchased product, to identify purchased products present in the social content.

At block 314, a product interest profile for the customer is generated and/or updated. The product interest profile can include data related to customer interactions with a particular product. Such a profile can also include what metadata was used to identify the product in the customer's social content. The product interest profile can be updated over time. In some embodiments, the product interest profile can be updated at predefined time intervals. In other embodiments, the product interest profile can be updated each time a customer buys a product (e.g., the profile can include information related to every product a customer has bought from a particular company).

At block 316, the product interest profile is integrated into a customer profile. A customer profile can include data related to online behavior (e.g., products viewed, pages visited, frequency of visiting, number of visits before making a purchase, acquisition channels to get to website), devices used, purchases made, explicitly observed profile information (e.g., name, social handles for various social channels), inferred profile information (e.g., gender), social perspective (e.g., number of posts, number of followers, who is following), etc.

Blocks 306 to 316 can be repeated for additional customers identified as individuals who purchased the selected product. The process can be repeated for any number of iterations or until all customers identified as purchasing the selected product are analyzed.

At block 318, a product interest profile is generated and/or updated for a potential customer. A potential customer can be an individual that leaves one or more pieces of engagement objects corresponding to social content generated by a customer that relates to a purchased product. Analyzing engagement objects provides insight into what other individuals related to the customer think about the purchased product. This insight can lead to some of those individuals being identified as potential customers. Using the one or more of engagement objects corresponding to the social content generated by the customer that relates to a purchased product, a likelihood of interest in the product can be determined for the individual that generated the engagement object. At block 320, the product interest profile is integrated into a customer profile for the potential customer. In some embodiments, the potential customer can be identified as having an existing customer profile (e.g., using, for example, one or more social handles). In other embodiments, a customer profile can be created for the potential customer. When the potential customer does not have an existing customer profile, the potential customer can be targeted via the social channel.

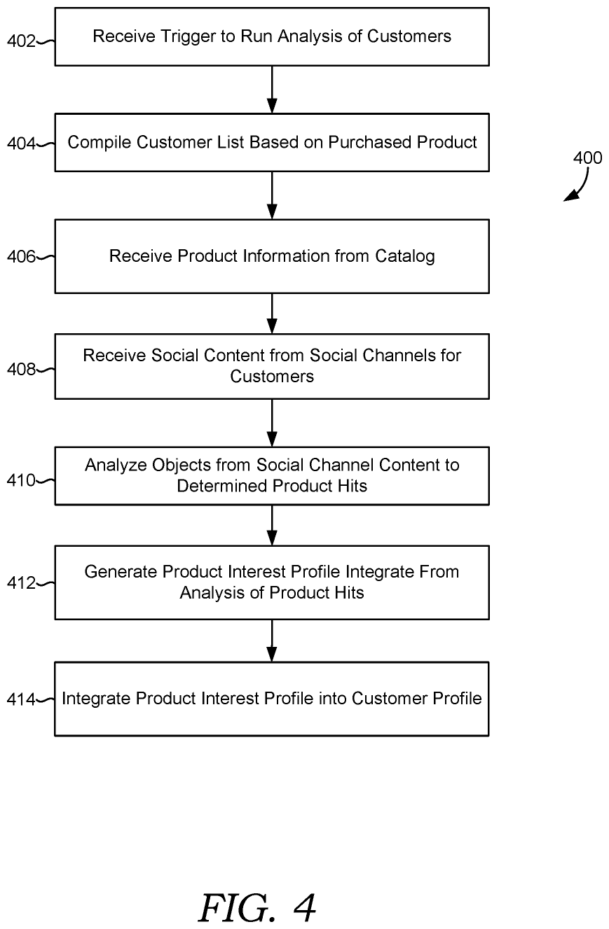

Turning now to FIG. 4, a process flow shows an embodiment of method 400 for generating product interest profiles, in accordance with embodiments of the present disclosure. Method 400 can be performed, for example by product analytics system 204, as illustrated in FIG. 2.

At block 402, a trigger to run an analysis of customer purchases is received. Such a trigger can be an indication of a customer purchasing a product. Upon a customer purchasing a product, a timeline is initiated such that a particular product of interest (e.g., the product purchased by a customer) can be analyzed at particular time intervals (e.g., a week post-purchase, a month post-purchase, etc.). The time interval can be a user-selected time period. The information may include temporal factors, such as, for instance, a time period, a particular year, month, week, day, hour, minute, second, season, quarter, holiday, or any combination thereof. By allowing the user to specify a particular time period, the product analysis system can analyze products purchased within that time period. For instance, a user may wish to analyze products purchased in the past year. In further embodiments, the trigger can be a user selecting a product of interest for analysis. Upon selecting a product of interest for analysis, a timeline for product analysis can be selected.

At block 404, customers that have purchased the product of interest can be identified. For instance, customers can be identified from a purchase database. Such a purchase database can include purchases made from a company website and/or made in company brick-and-mortar stores. Upon identifying the customers, a list of the customers can be generated. A purchase timeframe can be set for which to compile the list (e.g., last week, month, six months, etc.). Once a customer list is generated, the customer list can be filtered. Filters can be chosen to narrow the list to only customers of interest. In an embodiment, the list can be filtered based on customers with social channels linked to a customer profile (e.g., a customer profile for a company from which the product was purchased from). In other embodiments, if a particular customer segment is of interest, the customer list can be filtered to identify customers within that particular customer segment that purchased the object of interest. For instance, filters can be based on customer characteristics, such as, age, gender, interests, and/or geolocation. By allowing a user to specify a particular visitor segment, customer social channels related to that customer segment will be analyzed. For instance, a user may wish to analyze how customers that are females, aged 25-40 interact with a particular product.

At block 406, product information related to the product of interest is received from a catalog. In particular, metadata can be received from a back-end catalog using a product identifier. Metadata can include data related to information for generating the webpage of a company related to the product of interest (e.g., product images, product sizing information, color scheme information, product descriptions, etc.). Such metadata can also include behind-the-scenes information not typically disclosed to a customer (e.g., actual cost of a product).

At block 408, social content from customer's social channels is received. In particular, social content can be received for a particular timeframe (e.g., the past week, month, three months, etc.). Social content can be obtained from one or more social channels for a customer, and may include one or more social “posts” or pieces of social content, each of which can include at least one of a media object, a text object, and/or an engagement object, or any combination thereof. At block 410, objects can be analyzing from the social channel content. In particular, objects can include image objects and textual objects. In an embodiment, a customer's available social content can be analyzed (e.g., using image recognition), based on catalog metadata related to a purchased product, to identify purchased products present in the social content. Various techniques can be employed to identify social content and/or objects related to the social content that relates to the purchased product. One technique utilized can be a machine learning processes. Machine learning processes can, in some embodiments, be employed to determine products are visually or textually related to a piece of social content. Social content with objects positively identified as related to a particular product can then be analyzed to determine post-purchase interactions by the customer. Post-purchase interactions can be indicative of motivation for the customer for having purchased the product in the first place, customer satisfaction with the product, how/how often the customer is using the product, etc.

At block 412, product interest profiles is generated by integrating the analysis of product hits. The product interest profile can include data related to customer interactions with a particular product. The product interest profile can be updated over time. In some embodiments, the product interest profile can be updated at predefined time intervals. In other embodiments, the product interest profile can be updated each time a customer buys a product (e.g., the profile can include information related to every product a customer has bought from a particular company). At block 414, the product interest profile can be integrated into a customer profile for the customer. The product interest profile can be used, for instance, for greater personalization when generating targeted marketing campaigns to the customer.

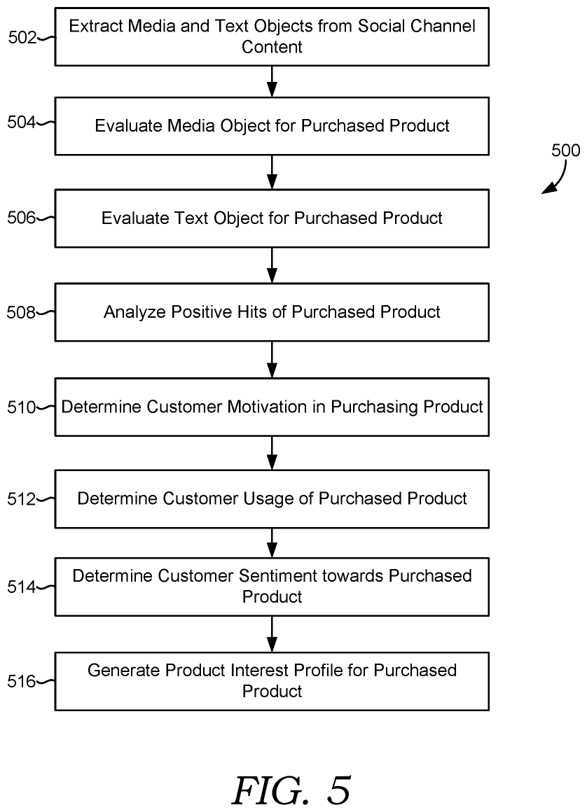

FIG. 5 provides a process flow showing an embodiment of method 500 for generating a product interest profile for a customer using objects extracted from social channel content, in accordance with embodiments of the present disclosure. Method 500 can be performed, for example by purchase analysis system 204, as illustrated in FIG. 2.

At block 502, media and text objects are extracted from social channel content. Media objects can include images, videos, audio, any other electronic media that can be publicly shared. Text objects can include URLs, captions, quotes, passages, journal entries, etc. In some configurations, a media object and/or text object of social content can be extracted using a parser to access a URL associated with the social channel and download raw media files and/or raw text files related to the social content. In some other configurations, media objects and/or text objects of each piece of social content can be extracted using a web crawler to access the URL associated with each piece of social content and download raw media files and/or raw text files from each URL as necessary.

At block 504, a media object is evaluated for a purchased product. For instance, the media object can be analyzed to determine whether the purchase product is featured. As an example, if the purchased product is a shirt, the shirt could be featured in an image when the customer is wearing the shirt and pointing at the shirt. It is contemplated that machine learning processes can evaluate a media object associated with a piece of social content to identify a purchased product. By way of example, an image of a user wearing a purchased product can be analyzed by machine learning processes to identify the presence of the purchased product in the image.

At block 506, a text object is evaluated for a purchased product. Related text object can also be analyzed to determine whether the purchase product is featured. As an example, if the purchased product is a shirt, the shirt could be featured in an image when the customer is wearing the shirt and the social content is captioned with a text object “Look at my awesome new shirt!” Various techniques can be used to compare metadata related to the purchased product with the text object.

At block 508, social content determined to contain the purchased product is further analyzed. Such analysis can include analyzing the social content objects to determine whether the social content is about the purchased item or whether the purchased product is just visible in the social content. This analysis can be performed by analyzing the media objects, text objects, and/or engagement objects to determine additional contextual information about the social content. For instance, the media objects, text objects, and/or engagement objects can be analyzed to determine whether the purchase product is featured in the social content. Various techniques can be applied to analyze the social content related to the purchased product. In one embodiment, machine learning can be applied to determine whether a purchased product is featured in social content.

At block 510, customer motivation in purchasing the product is determined. Motivation for purchasing a product can be determined post-purchase based on how a customer uses the purchased product. As an example, if a customer searches for hiking boots and then buys hiking boots. Post-purchase usage of the hiking boots can be analyzed using social content for the customer. In particular, a customer can use the hiking boots to go hiking in the desert. Motivation can be an advantageous piece of a customer journey when using lookalike modeling to make recommendation to similar customers based on customer segmentation. In the above example, if a second customer is determined to be similar to the customer that searched for hiking boots, the assumption can be made to treat the second customer similar to the initial customer. For instance, if the initial customer purchased crampons along with the hiking boots, crampons can be suggested to the second customer.

At block 512, customer usage of a purchased product is determined. Customer usage can be determined based on a number of times that the customer is determined to use, wear, interact with, and/or use the purchased product within a designated timeframe. For instance, a customer usage metric can be used to express customer usage. The customer usage metric can be an explicit countable metric (e.g., the product showed up in a piece of social content=+1, the product was used=+1, etc.).

At block 514, customer sentiment towards a purchased product is determined. Customer sentiment can be determined based on media object analysis and/or text objects related to the social content. Media object analysis can be performed using a variety of techniques including a sentiment identifier trained using machine learning. For instance, if a customer is wearing a newly purchased hat and smiling in a piece of social content, sentiment can be inferred (e.g., that the customer likes the hat). Sentiment about a purchase product can also have a temporal aspect. For example, if a customer bought a dress three years ago and the dress still shows up regularly in social content posted by the customer, sentiment can be inferred (e.g., that the customer really likes the dress). Sentiment can further be inferred based on customer usage metrics, or how often a customer uses a product. Further, sentiment can more directly be determined based on text objects related to the social content. When text accompanies a piece of social content, the text can convey a customer's sentiment (e.g., “BOOOOO, my brand new hat just broke, what a waste of $$$.” “My new hat is AMAZING!! !”).

At block 516, a product interest profile is generated for the customer related to the purchased product. The product interest profile can include the determined customer motivation, customer usage, and customer sentiment related to customer interactions with a particular product. The product interest profile can be updated over time (e.g., as product usage increases over time, customer usage can be updated). In some embodiments, the product interest profile can be updated at predefined time intervals. In other embodiments, the product interest profile can be updated each time a customer buys a product (e.g., the profile can include information related to every product a customer has bought from a particular company). Such a product interest profile can be integrated into a customer profile.

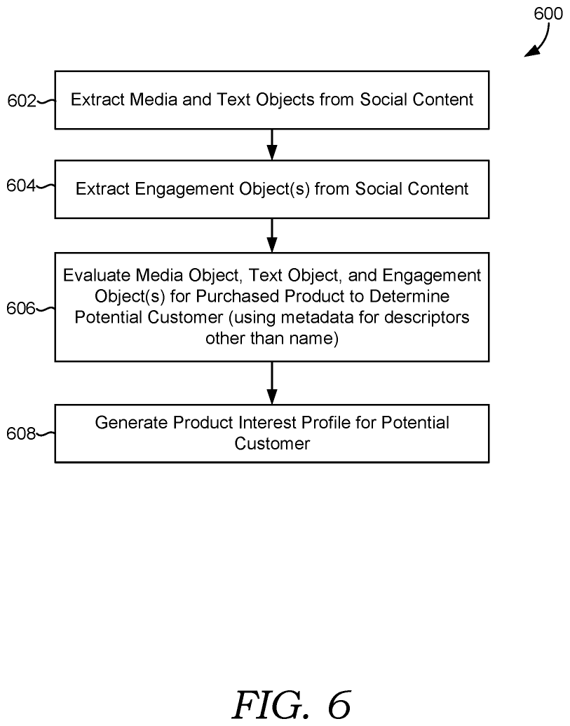

FIG. 6 provides a process flow showing an embodiment of method 600 for generating a product interest profile for a potential customer using objects extracted from social channel content, in accordance with embodiments of the present disclosure. Method 600 can be performed, for example, purchase analysis system 204, as illustrated in FIG. 2.

At block 602, media and text objects are extracted from social channel content. Social content can include media objects (e.g., images, videos, audio, any other electronic media that can be publicly shared by an entity on a network, such as the Internet, or any combination thereof) and/or a text objects (e.g., URLs, captions, quotes, passages, journal entries, etc.). In some configurations, a media object and/or text object of social content can be extracted using a parser to access a URL associated with the social channel and download raw media files and/or raw text files related to the social content. In some other configurations, media objects and/or text objects of each piece of social content can be extracted using a web crawler to access the URL associated with each piece of social content and download raw media files and/or raw text files from each URL as necessary.

At block 604, engagement objects are extracted from social channel content. Engagement objects for each piece of social content can include a total number of views, unique visitors, likes, dislikes, emoticons (e.g., happy face, sad face), shares, retweets, comments, hashtags, references, URLs, and the like. The engagement objects may also include information regarding each view or unique visitor, such as time stamps when accessed, length of time viewed, and visitor characteristics (e.g., demographics such as gender, age, geolocation, etc.). In some configurations, an engagement object of social content can be extracted using a parser to access a URL associated with the social channel and download raw engagement files related to the social content. In some other configurations, engagement objects of each piece of social content can be extracted using a web crawler to access the URL associated with each piece of social content and download raw engagement files from each URL as necessary.

At block 606, the media object, text object, and/or engagement objects are evaluated to determine whether the purchased product is in the social content. As an example, if the purchased product is a shirt, the shirt could be depicted in an image when the customer is wearing the shirt and the social content is captioned with a text object “Look at my awesome new shirt!” Engagement objects related to the social content with identified purchased products can also be analyzed. Such interactions can include comments, opinions, “likes”, “dislikes”, “tweets”, “retweets”, hashtags, usernames, user references, emoticons, ASCII art, images, animations, videos, audio, text, URLs, any other electronic media that can be publicly shared. Analyzing engagement objects provides insight into what other individuals related to the customer think about the purchased product. This insight can lead to some of those individuals being identified as potential customers. Potential customers can be identified based on engagement objects indicating a high likelihood of interest in purchasing the product (e.g., “I love this shirt, where can I buy it!”).

A potential customer can be an individual that leaves one or more pieces of engagement objects corresponding to social content generated by a customer that relates to a purchased product. Using the one or more of engagement objects corresponding to the social content generated by the customer that relates to a purchased product, a likelihood of interest in the product can be determined for the individual that generated the engagement object. In embodiments, engagement objects related to the social content with identified purchased products can be analyzed. Analyzing engagement objects provides insight into what other individuals related to the customer think about the purchased product. This insight can lead to some of those individuals being identified as potential customers.

At block 608, a product interest profile is generated for the potential customer. The product interest profile can include data related to customer interactions with a particular product. For instance, the product interest profile can include the engagement object related to the product. The product interest profile can be updated over time (e.g., to reflect if the potential buys the product and/or another related product). In some embodiments, the product interest profile can be updated at predefined time intervals. In other embodiments, the product interest profile can be updated each time a customer buys a product (e.g., the profile can include information related to every product a customer has bought from a particular company). Such a product interest profile can be integrated into a customer profile.

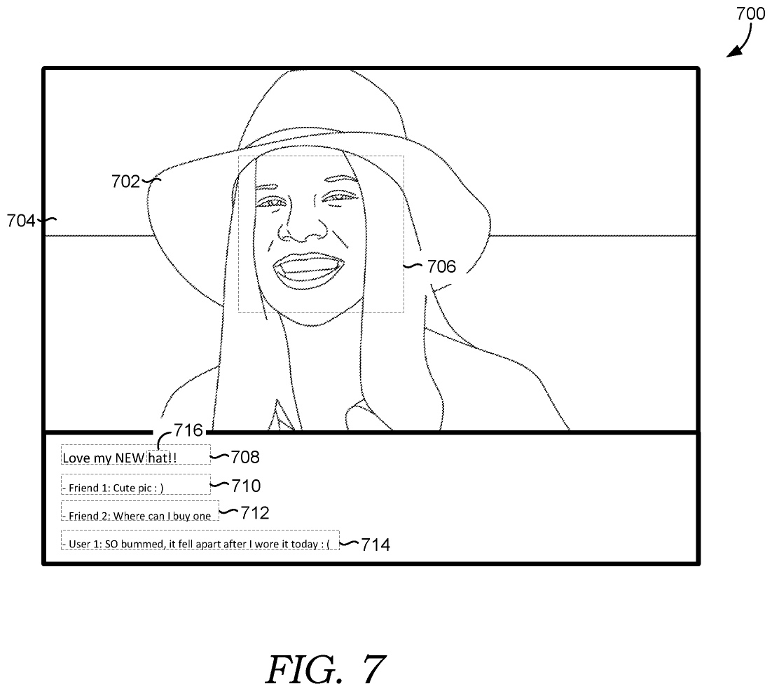

FIG. 7 depicts an illustrative piece of analyzed social content, in accordance with various embodiments of the present disclosure. FIG. 7 provides an example in which the purchased item is hat 702. Social content 700 can be analyzed by a product analytics system to generate a product interest profile for the purchase product (i.e., hat 702). Social content 700 can be analyzed to determine whether the purchased item hat 702 is present in the social content.

As illustrated, FIG. 7 shows media object 704 is present. In addition, text object 708 is present. Further, engagement objects 710-714 are present. Media object 704, text object 708, and/or engagement objects 710-714 can be analyzed to determine whether the purchased item of interest, hat 702, is present. Upon determining that hat 702 is present (e.g., based on image analysis of media object 704 and/or text analysis of hat text 716), social content 700 can be further analyzed to determine post-purchase interactions with hat 702. For instance, customer sentiment can be analyzed based on how the customer appears to reacts to hat 702, using, for example, facial analysis 706. In addition, customer sentiment can be analyzed based on text objects and/or engagement objects. For example, text object 708 indicates that the customer loves the hat and engagement object 714 indicates that the customer is disappointed in the product because it fell apart.

Customer motivation can also be analyzed. For example, if social content 700 is part of a posted album named “My Vacation in Sunny Hawaii,” then motivation could be that a hat was needed for a sunny vacation. Customer usage can also be analyzed. For example, if hat 702 was purchased a year before social content 700 was generated, each time the hat appeared in social content can be used to generate customer usage.

Information gathered from social content 700 can be used, for instance, to generate a product interest profile. From this profile, a company can identify information about a customer that can be used to generated targeted marketing. For example, if a company knows that the customer in social content 700 loves her hat and it just fell apart, directed campaign materials can be sent to the customer via email, using a customized home page when visiting the company website, via social channels, etc.

Further, engagement objects 710-712 can be analyzed to determine potential customers. For example, if Friend 2 is a known customer (e.g., based on the social handle of Friend 2 matching a social handle in a customer profile), then Friend 2 can be treated as a potential customer. In particular, Friend 2 can have a product interest profile indicating a likelihood of interest in hat 702. This product interest profile can be used in providing targeted marketing to Friend 2.

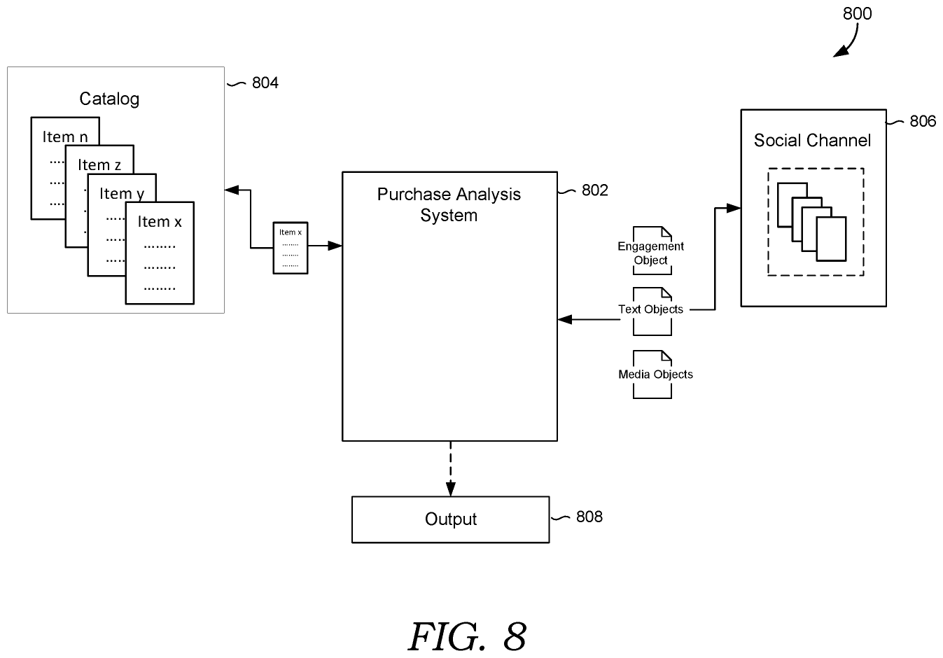

FIG. 8. depicts an illustrative process of implementing a purchase analysis system, in accordance with various embodiments of the present disclosure. Purchase analysis system 802 can interact with catalog 804 and social channel 806 to analyze social content of a particular customer as related to a purchased product. Catalog 804 can provide metadata related to the purchased product such that the product can be identified in the social content of social channel 806. In an embodiment, upon identifying a piece of social content from social channel, related media objects, text objects, and/or engagement objects can be received by purchase analysis system 802. These objects can be analyzed for post-purchase customer interactions to generate an output 808. Such an output can be a product interest profile.

Having described embodiments of the present invention, FIG. 9 provides an example of a computing device in which embodiments of the present invention may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, RGB camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method, comprising:
receiving product metadata from a catalog, the product metadata related to the product purchased by the customer;
receiving social content of the customer from a social channel;
analyzing, using the product metadata, an object in the social content of the customer for a post-purchase interaction with the product purchased by the customer; and
generating, based on the post-purchase interaction, a product interest profile for the customer related to the product.

2. The computer-implemented method of claim 1, wherein the object is one or more of a media object, a text object, and an engagement object.

3. The computer-implemented method of claim 1, further comprising:
analyzing the post-purchase interaction to determine a motivation of the customer to buy the purchased product.

4. The computer-implemented method of claim 1, further comprising:
analyzing the post-purchase interaction to determine a customer sentiment of the customer towards the purchased product.

5. The computer-implemented method of claim 1, further comprising:
analyzing the post-purchase interaction to determine customer usage of the purchased product.

6. The computer-implemented method of claim 1, further comprising:
further analyzing the object in the social content to determine a potential customer based on a likelihood of interest in the purchased product by the potential customer.

7. The computer-implemented method of claim 6, further comprising:
generating a different product interest profile for the potential customer related to the purchased product.

8. The computer-implemented method of claim 1, further comprising:
compiling a customer list based on customers that purchased the product; and
filtering the customer list to contain only the customers for which social handles of one or more social channels are known.

9. One or more computer storage media storing computer-useable instructions that, when used by one or more computing devices, cause the one or more computing devices to perform operations comprising:
receiving a trigger for analysis of a product;
receiving product metadata from a catalog, the product metadata related to the product;
receiving social content from a social channel of a customer who purchased the product;
analyzing, using the product metadata, an object in the social content of the customer for a post-purchase interaction with the product purchased by the customer, wherein the social content includes an image object depicting the post-purchase interaction with the product;
determining a sentiment based on the social content of the customer comprising at least one of the image object depicting the post-purchase interaction with the product and a text object corresponding to the social content indicating how the customer feels about the product; and
generating, based on the post-purchase interaction and the sentiment, a product interest profile for the customer related to the product.

10. The one or more computer storage media of claim 9, the operations further comprising:
compiling a customer list based on customers that purchased the product; and
filtering the customer list to contain only the customers for which at least one social handle is known for one or more social channels.

11. The one or more computer storage media of claim 9, the operations further comprising:
analyzing the post-purchase interaction to determine a motivation of the customer to buy the purchased product.

12. The one or more computer storage media of claim 9, the operations further comprising:
analyzing the post-purchase interaction to determine a customer sentiment of the customer towards the purchased product.

13. The one or more computer storage media of claim 9, the operations further comprising:
analyzing the post-purchase interaction to determine a customer usage by the customer of the purchased product.

14. The one or more computer storage media of claim 13, the operations further comprising:
analyzing further social content of the customer from the social channel to further determine the customer usage by the customer of the purchased product.

15. The one or more computer storage media of claim 9, wherein the object is one or more of a media object, a text object, and an engagement object.

16. The one or more computer storage media of claim 9, the operations further comprising:
further analyzing the object in the social content to determine a potential customer based on a likelihood of interest in the purchased product by the potential customer; and
generating a different product interest profile for the potential customer related to the purchased product.

17. A computing system comprising:
means for analyzing social content for a presence of a purchased product;
means for determining post-purchase customer interactions with the purchased product based on the social content; and
means for generating product interest profiles based on the post-purchase customer interactions with the purchased product.

18. The computing system of claim 17, further comprising:
means for analyzing the post-purchase customer interactions with the purchased product to determine at least one of a motivation of the customer to buy the purchased product, a customer sentiment of the customer towards the purchased product, and a customer usage by the customer of the purchased product.

19. The computing system of claim 17, wherein the presence of the purchased product is determined based on analysis of one or more objects in the social content, the objects comprising a media object, a text object, and an engagement object.

20. The computing system of claim 17, further comprising
means for further analyzing the social content to determine a potential customer based on a likelihood of interest in the purchased product by the potential customer.
